(19) United States
(12) Patent Application Publication
(10) Pub. No.: US 2021/0180591 A1
(43) Pub. Date: Jun. 17, 2021

(54) INTERNAL GEAR PUMP

(71) Applicant: NTN CORPORATION, Osaka (JP)

(72) Inventors: Tomokazu SONOZAKI, Mie (JP); Hiroshi AKAI, Mie (JP); Kei HATTORI, Mie (JP); Takayuki ITO, Mie (JP)

(21) Appl. No.: 16/768,800

(22) PCT Filed: Nov. 30, 2018
(86) PCT No.: PCT/JP2018/044154

§ 371 Date: Jun. 1, 2020

(30) Foreign Application Priority Data
Nov. 30, 2017 (JP) 2017-230482
Nov. 30, 2018 (JP) 2018-224526

(51) Int. Cl. F04C 2/10

(52) U.S. Cl. CPC F04C 2/10; F04C 2240/30

(57) ABSTRACT

Provided is an internal gear pump in which a casing and a cover can be easily positioned to each other when the casing and the cover are assembled, and they can be prevented from separating or falling off. In an internal gear pump 1, at least one of a casing 5 and a cover 6 is a molded body of a resin composition and the like. The casing 5 and the cover 6 are fixed with a plurality of protrusion parts protruding from one of the casing 5 and the cover 6 fitted in the other. The protrusion parts protrude from the casing of metal bushes 9 fixed to the casing 5, and the casing 5 and the cover 6 are integrated by bolts 13 passing through the metal bushes 9 across these two members.

### TECHNICAL FIELD

The present invention relates to an internal gear pump (a trochoid (registered trademark, the same applies below) pump) that pumps liquid such as oil, water, and chemical solution, and more particularly, to an internal gear pump used in an industrial machinery field, for example, an air conditioning compressor.

### BACKGROUND ART

An internal gear pump is a pump in which an outer rotor and an inner rotor having a trochoid tooth profile are accommodated in a casing in a sealed state, and the inner rotor and the outer rotor fixed to a driving shaft rotate together with the rotation of the driving shaft, so that liquid is sucked and discharged. In recent years, as such a type of pump, a pump having a resin casing has been known as a pump which can reduce a machining process and can be manufactured at a low cost (see Patent Literature 1).

On the basis of FIG. 5, the structure of such a type of internal gear pump will be described. FIG. 5 is a sectional view of an internal gear pump of the related art. As illustrated in FIG. 5, this pump 21 is mainly composed of a trochoid 24 in which an inner rotor 23 having a plurality of external teeth is accommodated in an annular outer rotor 22 having a plurality of internal teeth. The trochoid 24 is rotatably accommodated in a circular trochoid accommodation recessed part 25a formed in a columnar casing 25 with a flange. A cover 26 is fixed to the casing 25 to close the trochoid accommodation recessed part 25a. A driving shaft 27 rotated by a driving source (not illustrated) penetrates and is fixed to an axial center of the inner rotor 23.

The cover 26 is made of a sintered metal and the casing 25 is an injection molded body manufactured by injection molding using a resin composition. The casing 25 and the cover 26 are fastened and fixed to a fixed plate 30 of an actual device by a bolt 29 passing through a metal bush 28 provided in the casing 25. The casing 25 and the cover 26 have a mutually flat planar shape and seal the trochoid accommodation recessed part 25a.

### PRIOR ART DOCUMENTS

### Patent Documents

Patent Literature 1: JP 2014-51964 A

### SUMMARY OF THE INVENTION

### Problems to be Solved by the Invention

As described above, such an internal gear pump is bolted in a state in which the resin casing and the metal cover overlap each other when being mounted on an actual device. In general, since a resin molded article has low mechanical strength, the strength of the fastening part is improved by insert-molding the aforementioned metal bush. However, since a boundary surface between the casing and the cover is a plane, it is necessary to visually confirm a deviation and the like of a bolt hole in the metal bush on the casing side and the cover, and to perform the positioning of the casing and the cover. Furthermore, when being mounted on the actual device or during transport, the housing and the cover may separate or may fall off. In particular, when being mounted on the actual device, the housing and the cover may fall off and workability may deteriorate due to the mounting posture of the pump.

An object of the present invention is, in order to solve such a problem, to provide an internal gear pump in which a casing and a cover can be easily positioned to each other when the casing and the cover are assembled, they can be prevented from separating or falling off, and mechanical strength is further improved as needed.

### Means for Solving the Problem

An internal gear pump according to the present invention is an internal gear pump in which an inner rotor having a plurality of external teeth is accommodated inside an outer rotor having a plurality of internal teeth in an eccentrically rotatable manner with the external teeth and the internal teeth interdigitated with each other, and a suction-side volume chamber for sucking liquid and a discharge-side volume chamber for discharging the liquid sucked into the suction-side volume chamber are formed between the internal teeth and the external teeth and includes: a casing formed with a recessed part for accommodating the outer rotor and the inner rotor; and a cover that closes the recessed part of the casing. The casing and the cover are fixed with a plurality of protrusion parts protruding from one of the casing and the cover fitted in the other.

At least one of the casing and the cover includes a molded body of a resin composition. Alternatively, at least one of the casing and the cover includes a metal molded body.

The casing and the cover are integrated with each other by a fixing member passing through a metal bush across the casing and the cover, and at least one of the protrusion parts is a protrusion part of the metal bush protruding from one of the casing and the cover and fixed thereto.

Furthermore, in an embodiment using the molded body of the resin composition and the metal bush, the metal bush is a sintered metal bush, the molded body is an injection molded body of the resin composition, and the metal bush is provided integrally with the injection molded body of one of the casing and the cover during injection molding of the injection molded body.

At least one of the protrusion parts is a claw part protruding as a part of the molded body in one of the casing and the cover.

The resin composition is a resin composition in which a polyphenylene sulfide (PPS) resin is used as a base resin, and at least one selected from a glass fiber, a carbon fiber, and an inorganic filler is blended in the polyphenylene sulfide resin.

### Effects of the Invention

In the internal gear pump according to the present invention, the casing and the cover are fixed with a plurality of protrusion parts protruding from one of the casing and the cover fitted in the other, so that the casing and the cover can be easily positioned to each other when the casing and the cover are assembled, they can be prevented from separating or falling off, and workability is improved.

When at least one of the casing and the cover is a molded body of a resin composition, the characteristics of the resin composition are utilized, so that the casing and the cover can be further easily positioned to each other when the casing and the cover are assembled, they can be prevented from separating or falling off, and workability is further improved.

Furthermore, when at least one of the casing and the cover is a metal molded body, the mechanical strength of the casing and the cover is improved, and the casing and the cover can be easily positioned to each other when the casing and the cover are assembled, they can be prevented from separating or falling off.

Since the casing and the cover are integrated with each other by the fixing member passing through the metal bush across the casing and the cover and at least one of the protrusion parts is a protrusion part of the metal bush protruding from one of the casing and the cover and fixed thereto, when the casing and the cover are assembled, it is possible to facilitate the positioning of the casing and the cover by fitting the protrusion part of the metal bush in one of the casing and the cover in the fitting part for the protrusion part of the other. Furthermore, the strength of the fastening part of the casing and the cover is improved by the metal bush and it is possible to prevent the loosening of the fastening part due to the creep deformation of a resin.

In an embodiment in which at least one of the casing and the cover is the molded body of the resin composition and uses the metal bush, since the metal bush is a sintered metal bush and the metal bush is provided integrally with the injection molded body of one of the casing and the cover during injection molding of the injection molded body, that is, since the metal bush is integrated by composite molding after a bush is disposed in a mold during the injection molding, the resin enters a recessed part on the surface of the sintered metal of the bush, so that the bonding strength of the casing and the cover is excellent due to an anchor effect. In this way, even when the bush is designed to protrude longer from the injection molded body such as the casing, it is possible to prevent detachment of the bush during transport or mounting.

Since the resin composition is a resin composition in which a PPS resin is used as a base resin and at least one selected from a glass fiber, a carbon fiber, and an inorganic filler is blended in the PPS resin, it is superior in dimensional accuracy or toughness and the aforementioned effect is easily obtained. Furthermore, it is superior in oil resistance and chemical resistance, and can also be used in a high temperature atmosphere exceeding 120° C. of a compressor and the like.

When at least one of the casing and the cover is the molded body of the resin composition, since at least one of the protrusion parts is a claw part protruding as a part of the molded body, the claw part is also a part of the resin molded body, is easily elastically deformed, and is superior in toughness, and it is possible to prevent breakage and the like during assembling.

Furthermore, when at least one of the casing and the cover is the metal molded body, since at least one of the protrusion parts is a claw part protruding as a part of the molded body, the claw part is also a part of the metal molded body, has an excellent mechanical strength, and it is possible to breakage and the like during assembling.

### BRIEF DESCRIPTION OF THE DRAWINGS

FIG. 1 is an assembled perspective view illustrating an example of an internal gear pump according to the present invention.

FIG. 2 is an axial sectional view of the internal gear pump of FIG. 1.

FIG. 3 is an assembled perspective view illustrating another example of an internal gear pump according to the present invention.

FIG. 4 is a complete perspective view of the internal gear pump of FIG. 3.

FIG. 5 is an axial sectional view of an internal gear pump of the related art.

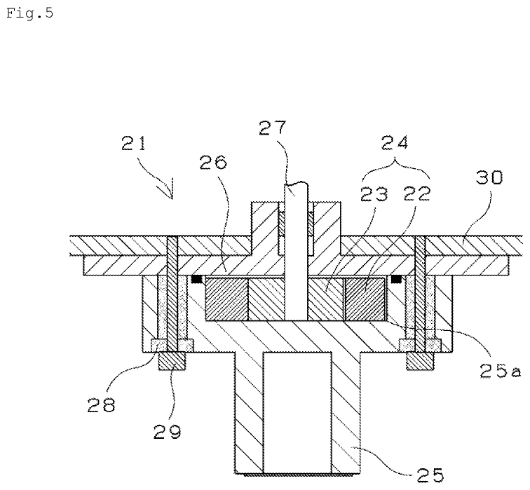

### MODE FOR CARRYING OUT THE INVENTION

The present invention relates to an internal gear pump including a trochoid in which an inner rotor having a plurality of external teeth is accommodated inside an outer rotor having a plurality of internal teeth in an eccentrically rotatable manner with the external teeth and the internal teeth interdigitated with each other, and a suction-side volume chamber for sucking liquid and a discharge-side volume chamber for discharging the liquid sucked into the suction-side volume chamber are formed between the internal teeth and the external teeth. The internal gear pump includes a casing formed with a recessed part for accommodating the outer rotor and the inner rotor constituting the trochoid, and a cover that closes the recessed part of the casing.

In the internal gear pump according to the present invention, the casing and the cover are fixed with a plurality of protrusion parts protruding from one of the casing and the cover fitted in the other. As the protruding part, for example, a metal bush fixed to a resin casing may be used, or a claw part provided on a resin or metal casing or cover may be used.

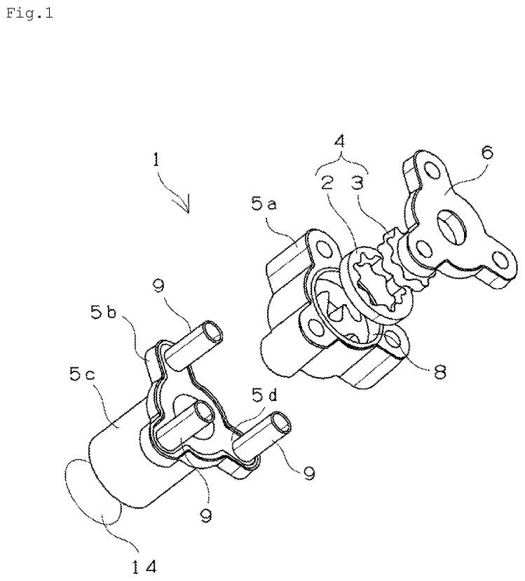

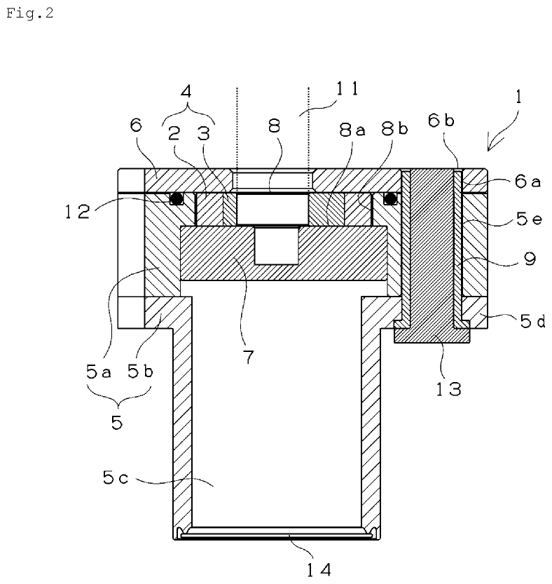

The internal gear pump using the metal bush will be described with reference to FIG. 1 and FIG. 2. FIG. 1 illustrates an assembled perspective view illustrating an example of the internal gear pump according to the present invention. FIG. 2 illustrates an axial sectional view of the internal gear pump of FIG. 1.

As illustrated in FIG. 1 and FIG. 2, an internal gear pump 1 includes a trochoid 4 in which an inner rotor 3 is accommodated in an annular outer rotor 2, a pump casing 5a formed with a circular recessed part (a trochoid accommodation recessed part) 8 for rotatably accommodating the trochoid 4, a suction casing 5b formed with a liquid suction part 5c, and a cover 6 that closes the trochoid accommodation recessed part 8 of the pump casing 5a. A casing 5 is composed of two members of the pump casing 5a and the suction casing 5b. The cover 6 has a shape coinciding with an outer shape of an upper surface of the casing 5 in which the trochoid accommodation recessed part 8 is opened. Three metal bushes 9 are fixed to the suction casing 5b. As illustrated in FIG. 2, the pump casing 5a, the suction casing 5b, and the cover 6 are fixed to a fixed plate of an actual device with bolts 13, which are fixing members passing through the metal bushes 9 across the casings and cover, and integrated with one another. The fixing member is not limited to the bolt 13, and any members may be used if they can fix each member and, for example, a screw, a pin, and the like may be used. Furthermore, the internal gear pump 1 has a driving shaft 11 fixed coaxially to the rotation center of the inner rotor 3.

The number of external teeth of the inner rotor 3 is smaller than that of internal teeth of the outer rotor 2 by 1, and the inner rotor 3 is accommodated in the outer rotor 2 in an eccentric state in which the external teeth are inscribed in and interdigitated with the internal teeth. A volume chamber on the suction side and the discharge side is formed between partition points, where the rotors come into contact with each other, in accordance with the rotation direction of the trochoid 4. A bottom surface 8a of the trochoid accommodation recessed part 8 of the casing 5 is provided with a liquid flow passage including a suction port communicating with the volume chamber on the suction side and a discharge port communicating with the volume chamber on the discharge side. Liquid is pumped from the discharge port to a compression part (not illustrated) at an upper side in the drawing through a discharge flow passage at the center of the driving shaft 11.

In the internal gear pump 1, liquid is sucked from the suction port into the suction-side volume chamber of the pump, where its volume is increased and a negative pressure state is reached due to the rotation of the trochoid 4 by the driving shaft 11. The suction-side volume chamber is changed to the discharge-side volume chamber where its volume is decreased and internal pressure is increased due to the rotation of the trochoid 4, so that the sucked liquid is discharged from the discharge-side volume chamber to the discharge port. The aforementioned pump operation is continuously performed by the rotation of the trochoid 4, so that liquid is continuously pumped. Moreover, due to the liquid seal effect that the sealability of each volume chamber is enhanced by the sucked liquid, differential pressure between the volume chambers is increased, so that a large pump operation is obtained.

In the internal gear pump according to the present invention, at least one of the casing and the cover is a molded body (a resin body) of a resin composition. In this way, the pump can reduce a machining process and can be manufactured at a low cost. The internal gear pump according to the present invention has a configuration employing such a resin casing and the like, facilitates the positioning of the casing and the cover during assembling, and prevents separation or falling off of the casing and the cover. In the embodiment of FIG. 1 and FIG. 2, the almost whole of the casing 5 and the cover 6, that is, the cover 6, the pump casing 5a, and the suction casing 5b are made of a resin body and are integrated with one another by the metal bush 9 and the bolt 13. In addition, it is sufficient if a member for fixing at least the metal bush 9 is a resin body, and, for example, the cover 6 may be made of a metal (iron, a stainless steel, a sintered metal, an aluminum alloy, and the like).

As illustrated in FIG. 1 and FIG. 2, the metal bush 9 is fixed to a flange part 5d of the suction casing 5b. A protruding part of the metal bush 9 from the suction casing 5b is allowed to be fitted in a fitting part 5e of the pump casing 5a and a fitting part 6a of the cover 6, so that it is possible to facilitate the positioning of these. Furthermore, by interposing the metal bush 9, even when one or both of the casing 5 and the cover 6 is made of a resin body, it is possible to improve the strength of the fastening parts of the casing 5 and the cover 6 and to prevent the loosening of the fastening part due to the creep deformation of a resin. Moreover, during mounting or transport, it is possible to prevent separation or falling off of a temporary assembly (the casing and the cover). In addition, it is possible to prevent a foreign matter from entering the rotor part.

Furthermore, preferably, the length of the metal bush 9 is adjusted such that the distal end of the metal bush 9 during assembling does not protrude from an upper end surface 6b of the fitting part 6a of the cover 6. More preferably, the distal end of the metal bush 9 is shaped to be recessed from the upper end surface 6b of the fitting part 6a of the cover 6. In this way, it is possible to prevent interference between the fixed plate of an actual device and the metal bush 9.

The metal bush 9 can be made of any desirable metal such as an iron, a stainless steel, and a sintered metal; particularly preferably, the metal bush 9 is made of the sintered metal. When the metal bush is made of the sintered metal and is subjected to composite molding (insert molding) with the suction casing, since the resin enters a recessed part on the surface of the sintered metal of the bush, it is firmly bonded by an anchor effect.

In the pump casing, preferably, the inner side surface of the trochoid accommodation recessed part is made of a resin body and the bottom surface of the recessed part is made of a metal body. As illustrated in FIG. 2, the pump casing 5a is in sliding contact with the outer rotor 2 and the inner rotor 3 at the bottom surface 8a and an inner side surface 8b constituting the trochoid accommodation recessed part 8. The inner side surface 8b of the trochoid accommodation recessed part 8 is made of a resin body, so that the friction and abrasion properties with the outer rotor 2 are improved. Furthermore, the bottom surface 8a of the trochoid accommodation recessed part 8 is composed of a disk-like metal plate 7 integrated with the pump casing 5a by composite molding. In this way, flatness is improved compared to a case where the bottom surface 8a is made of a resin, and it is possible to suppress the variation of discharge performance. As the metal plate 7, it is possible to employ a sintered metal body or a molten metal body (a sheet-pressed component).

The casing 5 is composed of two members of the pump casing 5a and the suction casing 5b, so that the aforementioned composite molding (insert molding) of the metal plate 7 is facilitated. In the present invention, even when the number of parts is increased by separating the casing into a plurality of members, positioning is facilitated and assembling performance is improved due to a fitting structure using a plurality of protruding parts. Furthermore, the liquid suction part 5c is provided in the suction casing 5b. As needed, a filter 14 can be fixed to an end portion of the liquid suction part 5c serving as a communication passage inlet (a liquid suction port) up to the suction-side volume chamber by welding and the like. It is possible to prevent a foreign matter from entering the pump by the filter 14.

Furthermore, in the pump casing 5a, the trochoid accommodation recessed part 8 is provided on the outer peripheral part thereof with a groove, and a seal ring 12 is assembled to the groove. By assembling the seal ring 12, it is possible to prevent leakage of liquid from the matching surface of the pump casing 5a and the cover 6 and to suppress the variation in the discharge amount, and the safety factor becomes higher. Note that when it is possible to ensure sufficient sealability on a bonding surface of each member of the casing and the cover, the seal ring 12 may be omitted.

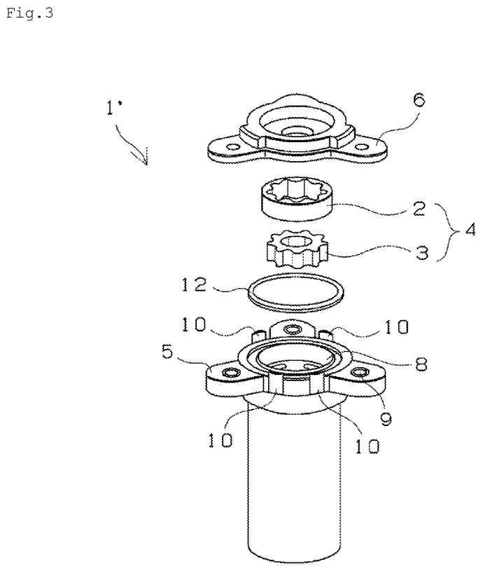

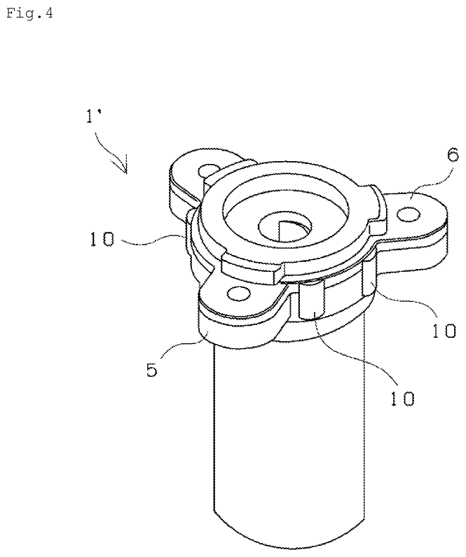

An internal gear pump using claw parts will be described on the basis of FIG. 3 and FIG. 4. FIG. 3 is an assembled perspective view illustrating another example of the internal gear pump, and FIG. 4 is a complete perspective view of the internal gear pump. As illustrated in FIG. 3 and FIG. 4, an internal gear pump 1′ includes a trochoid 4 in which an inner rotor 3 is accommodated in an annular outer rotor 2, a casing 5 formed with a trochoid accommodation recessed part 8, and a cover 6 that closes the trochoid accommodation recessed part 8. The cover 6 has a shape coinciding with an outer shape of an upper surface of the casing 5 in which the trochoid accommodation recessed part 8 is opened. The casing 5 is made of a resin. The casing 5 and the cover 6 are fixed to a fixed plate of an actual device with bolts (not illustrated) passing through metal bushes 9 fixed to the casing 5, and integrated with one another. The other basic configurations of the pump are the same as those illustrated in FIG. 1 and FIG. 2.

In this embodiment, the metal bush 9 is not fitted in the cover 6. On the other hand, the casing 5 is provided with four claw parts 10 protruding therefrom. These claw parts 10 are integrated with the casing 5 and are formed simultaneously with the molding of the resin casing 5. As illustrated in FIG. 4, at the time of assembling, the claw parts 10 are fitted (engaged) so as to hold an outer peripheral portion of the cover 6, so that positioning can be easily performed. Furthermore, since the claw part is made of a resin, it is easy to be elastically deformed and is superior in toughness, and it is possible to prevent breakage and the like during assembling. In addition, the shape and the number of the claw parts 10 are not particularly limited as long as the casing 5 and the cover 6 can be positioned.

In the aforementioned each embodiment, a resin composition forming the casing or the cover mainly employs an injection-moldable synthetic resin as a base resin. As the base resin, for example, there are a PPS resin, a thermoplastic polyimide resin, a polyether ketone resin, a polyether ether ketone (PEEK) resin, a polyamide-imide resin, a polyamide (PA) resin, a polybutylene terephthalate (PBT) resin, a polyethylene terephthalate (PET) resin, a polyethylene (PE) resin, a polyacetal resin, a phenol resin, and the like. These resins may be used alone or may be a polymer alloy in which two or more types of resins are mixed. Among these heat-resistant resins, it is particularly preferable to use the PPS resin because it is superior in creep resistance, load resistance, abrasion resistance, chemical resistance, and the like of molded body.

It is preferable to use a glass fiber, a carbon fiber, or an inorganic filler, which is effective for high strength, high elasticity, high dimension accuracy, and imparting abrasion resistance and removing anisotropy of injection molding shrinkage, alone or in combination as appropriate. In particular, the combination of the glass fiber and the inorganic filler is superior in economic efficiency and is superior in friction and abrasion properties in oil.

In the present invention, it is particularly preferable to use a resin composition in which the straight-chain PPS resin is used as a base resin and glass fibers and glass beads are blended in the base resin as a filler. Since this structure is superior in oil resistance, chemical resistance, and toughness, has a small warpage due to removal of the anisotropy of injection molding shrinkage, and significantly improves dimensional accuracy, it is particularly effective when both the cover and the casing are made of a resin.

The casing or the cover is molded by injection molding using molding pellets obtained from these raw materials. In the case of the members illustrated in FIG. 1 or FIG. 2, the aforementioned metal bush is arranged in a mold and is integrated by composite molding when the suction casing is molded. Furthermore, when the pump casing is molded, the aforementioned metal bush is arranged in a mold and is integrated by composite molding.

Furthermore, the casing or the cover can also be formed as a die-cast product, for example. As a material, for example, a low melting point alloy such as an aluminum alloy is preferable. Examples of the aluminum alloy die-cast products include Al—Si based alloys (ADC1), Al—Si—Mg based alloys (ADC3), Al—Mg based alloys (ADC5 and ADC6), Al—Si—Cu based alloys (ADC10, ADC10Z, ADC12, ADC12Z, and ADC14), and the like specified in JIS H 5302 (2006) and the like.

Furthermore, the casing or the cover can also be formed as a sintered metal product, for example. As the sintered metal, for example, an iron-based sintered metal and the like are preferable. More specifically, for example, an iron-based sintered metal, which has a pearlite phase in at least a surface layer portion, and, in which copper and tin are mixed to bond the iron structures, is preferable. In such a case, the iron structures are bonded by a copper-tin alloy. An example of the composition of this type of iron-based sintered metal will be described. The iron-based sintered metal contains 1 to 10 wt. % (preferably, 1 to 8 wt. %) of copper, 0.5 to 2 wt. % of tin, 0.1 to 0.5 wt. % of carbon, and the remainder being iron. The mixing ratio of tin to copper is ⅕ to 1 (inclusive) in a weight ratio. In the iron-based sintered metal, most of copper and tin exists as a copper-tin alloy and there is almost no structure of a copper simple substance or a tin simple substance. For example, the ratio of the copper simple substance to the copper component in the sintered metal is 5 wt. % or less, and the ratio of the tin simple substance to the tin component in the sintered metal is 0.1 wt. % or less. The density of such a sintered metal product is, for example, 6.6 g/cm³ or more, preferably, 6.8 g/cm³ or more, and, for example, 8.0 g/cm³ or less.

As a specific combination, for example, the casing is formed of the Al—Si—Cu-based aluminum alloy (ADC12), and the cover is formed of the iron-based sintered metal having a pearlite phase in at least a surface layer portion or the Al—Si—Cu-based die-cast aluminum alloy (ADC12).

Furthermore, in the internal gear pump according to the present invention, as a material of the outer rotor and the inner rotor, it is preferable to use a sintered metal (an iron-based, a copper-iron-based, a copper-based, a stainless steel-based metals, and the like), and the iron-based metal is particularly preferable in terms of cost. In addition, in the trochoid pump that pumps water, chemical solution, and the like, it is sufficient if the stainless steel-based metal with high rust preventing capacity and the like are employed.

So far, the case where the metal bush and the claw part are used as the protruding part has been described with reference to the accompanying drawings; however, the internal gear pump according to the present invention is not limited thereto. For example, both the metal bush and the claw part may be used. In addition, it is possible to employ any desirable structure in which a plurality of protruding parts protruding from one member are allowed to be fixedly fitted in another member.

### INDUSTRIAL APPLICABILITY

The internal gear pump according to the present invention can be widely used as an internal gear pump (a trochoid pump) that pumps liquid such as oil, water, and chemical solution because positioning during assembling of the casing and the cover is facilitated and it is possible to prevent separation or falling off of the casing and the cover. For example, the internal gear pump can be used as a pump for supplying liquid to sliding parts of a scroll-type compressor for an electric hot-water supply machine, a room air conditioner, or a car air conditioner, which uses substitutes for chlorofluorocarbon, carbon dioxide gas, and the like as a refrigerant.

### REFERENCE SIGNS LIST

1: internal gear pump
2: outer rotor
3: inner rotor
4: trochoid
5: casing
5a: pump casing
5b: suction casing
5c: liquid suction part
5d: flange part
5e: fitting part (suction casing)
6: cover
6a: fitting part (cover)
6b: upper end surface
7: metal plate
8: trochoid accommodation recessed part
8a: bottom surface
8b: inner side surface
9: metal bush
10: claw part
11: driving shaft
12: seal ring
13: bolt
14: filter

1. An internal gear pump in which an inner rotor having a plurality of external teeth is accommodated inside an outer rotor having a plurality of internal teeth in an eccentrically rotatable manner with the external teeth and the internal teeth interdigitated with each other, and a suction-side volume chamber for sucking liquid and a discharge-side volume chamber for discharging the liquid sucked into the suction-side volume chamber are formed between the internal teeth and the external teeth, the internal gear pump comprising:
a casing formed with a recessed part for accommodating the outer rotor and the inner rotor; and
a cover that closes the recessed part of the casing,
wherein the casing and the cover are fixed with a plurality of protrusion parts protruding from one of the casing and the cover fitted in another.

2. The internal gear pump according to claim 1, wherein at least one of the casing and the cover is a molded body of a resin composition.

3. The internal gear pump according to claim 1, wherein the casing and the cover are integrated with each other by a fixing member passing through a metal bush across the casing and the cover, and
at least one of the protrusion parts is a protrusion part of the metal bush protruding from one of the casing and the cover and fixed thereto.

4. The internal gear pump according to claim 1, wherein at least one of the casing and the cover includes a molded body of a resin composition,
the casing and the cover are integrated with each other by a fixing member passing through a metal bush across the casing and the cover, and
at least one of the protrusion parts is a protrusion part of the metal bush protruding from one of the casing and the cover and fixed thereto.

5. The internal gear pump according to claim 4, wherein the metal bush is a sintered metal bush, the molded body is an injection molded body of the resin composition, and
the metal bush is provided integrally with the injection molded body of one of the casing and the cover during injection molding of the injection molded body.

6. The internal gear pump according to claim 2, wherein at least one of the protrusion parts is a claw part protruding as a part of the molded body or a part of the injection molded body in one of the casing and the cover.

7. The internal gear pump according to claim 2, wherein the resin composition is a resin composition in which a polyphenylene sulfide resin is used as a base resin and at least one selected from a glass fiber, a carbon fiber, and an inorganic filler is blended in the polyphenylene sulfide resin.

8. The internal gear pump according to claim 1, wherein at least one of the casing and the cover is a metal molded body.

9. The internal gear pump according to claim 8, wherein the casing and the cover are integrated with each other by a fixing member passing through a metal bush across the casing and the cover, and
at least one of the protrusion parts is a protrusion part of the metal bush protruding from one of the casing and the cover and fixed thereto.

10. The internal gear pump according to claim 8, wherein at least one of the protrusion parts is a claw part protruding as a part of the molded body in one of the casing and the cover.

11. The internal gear pump according to claim 5, wherein at least one of the protrusion parts is a claw part protruding as a part of the molded body or a part of the injection molded body in one of the casing and the cover.

12. The internal gear pump according to claim 4, wherein the resin composition is a resin composition in which a polyphenylene sulfide resin is used as a base resin and at least one selected from a glass fiber, a carbon fiber, and an inorganic filler is blended in the polyphenylene sulfide resin.
